(19) United States
(12) Patent Application Publication
(10) Pub. No.: US 2025/0002102 A1
(43) Pub. Date: Jan. 2, 2025

(54) Seat Device for a Vehicle

(71) Applicant: BAYERISCHE MOTOREN WERKE AKTIENGESELLSCHAFT, München (DE)

(72) Inventors: Christian ISING, Muenchen (DE); Dieter STRASSER, Oberhausen (DE)

(21) Appl. No.: 18/708,786

(22) PCT Filed: Dec. 22, 2022
(86) PCT No.: PCT/EP2022/087539

§ 371 Date: May 9, 2024

(30) Foreign Application Priority Data
Jan. 19, 2022 (DE) 10 2022 101 143.7

(51) Int. Cl. B62J 1/10; B62J 1/18

(52) U.S. Cl. CPC B62J 1/10; B62J 1/18

(57) ABSTRACT

A seat device for a vehicle, in particular a tilting vehicle, has at least one flat padding unit which forms a seat surface for a user of the vehicle on a surface facing the user of the vehicle, at least one wall element with at least sections that are hard-shelled, on which the padding unit is secured, and at least one spring unit arranged between the padding unit and the wall element. The spring unit has at least one spring element which is arranged between the padding unit and the wall element, which can be detachably secured in or on the wall element, and with which a spring force acting between the padding unit and the wall element can be adjusted, with the force vector thereof running parallel or oblique to a spring direction extending transverse to the seat surface.

### BACKGROUND AND SUMMARY

The invention relates to a seat device for a vehicle.

Seat devices are known in various designs for vehicles, in particular for tilting vehicles. In the case of a tilting vehicle, the seat devices often comprise seat benches which are composed of a seat bench trough and a foam secured to the seat bench trough. The seat bench trough and foam are connected inseparably to each other and comprise an unchangeable foam hardness and a seat hardness resulting therefrom.

It has proven disadvantageous in this case that different users of one and the same vehicle prefer different seat hardnesses of the seat bench due to different body proportions and different body weights. In such a case, complete exchange of the seat device, in particular of the seat bench, is necessary for the respective user, which is complicated and costly.

It is an object of an exemplary embodiment of the invention to provide a seat device in which a hardness of the seat device is adjustable in a simplified way.

This object is achieved by a seat device for a vehicle, in particular tilting vehicle, having at least one planar padding unit which forms a seat surface for a user of the vehicle on a surface facing the user of the vehicle, having at least one trough element which is hard-shelled at least in sections and to which the padding unit can be secured, and having at least one spring unit which can be arranged or is arranged between the padding unit and trough element and at least one spring element which can be arranged or is arranged between the padding unit and trough element, can be secured or is secured releasably in or to the trough element and by means of which a spring force acting between the padding unit and trough element is adjustable, the force vector of which spring force runs parallel or obliquely to a spring direction extending transversely with respect to the seat surface.

Owing to the fact that the seat device comprises a spring unit which can be arranged or is arranged between the padding unit and trough element, a spring force acting between the padding unit and trough element is adjustable. By this means, a seat hardness of the seat device is adjustable without the padding unit and/or the trough element having to be exchanged. By this means, the seat device is adjustable to the requirements of different users of the vehicle simply and cost-effectively.

The vehicle may comprise a watercraft, aircraft or land vehicle, in particular a truck, a passenger motor vehicle or a tilting vehicle.

A tilting vehicle is understood as meaning bicycles, motorbikes or motor vehicles similar to motorbikes, such as motor scooters, in particular two-, three- or four-wheeled motor scooters, scooters, tiltable trikes, quad bikes, or the like.

The at least one spring element of the spring unit can be positioned simply and captively in or on the trough element if the trough element has a receptacle which comprises a cavity and is arranged in or on the trough element and into which the at least one spring element is introducible manually or automatically along a joining direction and is secured counter to a movement in the spring direction or a movement in the spring direction is limited.

Owing to the fact that the spring element is secured in the receptacle counter to a movement in the spring direction or a movement in the spring direction is limited, it is ensured that the at least one spring element acts with its spring force between the padding unit and trough element.

Embodiments of the seat device are contemplated, in which the trough element comprises, on a surface extending transversely or obliquely with respect to the seat surface, an opening through which at least one of the at least one spring elements is introducible into the receptacle and the joining direction runs transversely or obliquely with respect to the spring direction, and/or in which the padding unit can be transferred relative to the trough element from a secured arrangement into an open arrangement in which the receptacle is accessible from the outside and at least one of the spring elements is introducible into the receptacle, and the joining direction runs in or obliquely with respect to the spring direction, and/or in which the trough element, on the side facing away from the padding unit, comprises a cutout through which at least one of the at least one spring elements is introducible into the receptacle, and the joining direction runs in or obliquely with respect to the spring direction.

If the trough element comprises, on a surface extending transversely or obliquely with respect to the seat surface, an opening through which at least one of the spring elements is introducible into the receptacle, and the joining direction runs transversely or obliquely with respect to the spring direction, the at least one spring elements can be pushed into the trough element parallel to the surface of the seat surface. In such a case, the at least one spring element can be introduced into the receptacle in the trough element parallel or obliquely with respect to a transverse axis of the vehicle or transversely or obliquely with respect to a longitudinal axis of the vehicle.

If the padding unit can be transferred relative to the trough element from a secured arrangement into an open arrangement in which the receptacle is externally accessible and at least one of the spring elements is introducible into the receptacle, and the joining direction runs in or obliquely with respect to the spring direction, the at least one spring element can be placed into the receptacle parallel to a vertical axis of the vehicle. After the at least one spring element is placed into the receptacle in the trough element, in such a case the padding unit is transferred from the open arrangement back into the secured arrangement, in which the padding unit is secured in a fixed position with respect to the trough element.

If the trough element comprises, on the side facing away from the padding unit, a cutout through which at least one of the at least one spring element is introducible into the receptacle, and the joining direction runs in or obliquely with respect to the spring direction, the at least one spring element can be introduced from below into the trough element. In such a case, the joining direction is likewise parallel to a vertical axis of the vehicle.

In principle, it is contemplated that just one single spring element can be arranged in or on the trough element, in particular in the receptacle of the trough element. Furthermore, embodiments of the seat device are contemplated, in which the spring unit comprises at least two spring elements which are arranged running obliquely or parallel to one another.

If the seat device comprises more than one spring element, a seat hardness can be reinforced by the additional arrangement of further spring elements. If at least two of the at least two spring elements run parallel to one another, they can be arranged in the same receptacle or in two receptacles running parallel to each other.

In a development of the last-mentioned embodiment, it has proven advantageous if at least two of the at least two spring elements are formed from the same material or from different materials, wherein at least one of the at least two spring elements comprises a metal or a plastic, and/or if at least two of the at least two spring elements comprise the same spring rate or at least two of the at least two spring elements each comprise a spring rate differing from one another.

This makes it possible to use spring elements with a different hardness, i.e. with a different spring effect. By this means, different regions of the seat device can be configured with a different seat hardness.

Furthermore, a development of the seat device comprises at least one adjuster for adjusting the spring force of the system consisting of the at least two spring elements, which adjuster is movable along an adjustment direction running transversely or obliquely with respect to the spring direction, wherein movement of the adjuster along the adjustment direction enables a distance between the at least two spring elements with respect to one another to be adjustable.

If the at least two spring elements are arranged one above another running parallel to one another and overlapping one another, the adjuster can couple the at least two spring elements to one another by displacement, for example in a manner similar to a slatted frame of a bed. Depending on the position of the adjuster, in such a case a coupled spring rate and, by this means, a spring force are adjustable.

The at least two spring elements can comprise the same cross section or a cross section differing from one another.

Furthermore, a spring element can comprise a shape by which the receptacle is filled as a whole or which fills only a partial region of the receptacle. In such a case, a spring element can comprise a rod-shaped or a block-like contour.

If a plurality of spring elements are provided, they are introducible into the receptacle individually and independently of one another or jointly and coupled to one another and fill the receptacle as a whole or only in regions. In particular, the plurality of spring elements can be arranged in the receptacle in contact with one another or spaced apart from one another.

In one development, it is provided that the spring unit comprises at least one spring assembly which can be arranged in the at least one receptacle and has at least two spring elements which are arranged in particular running parallel to one another, are movable relative to one another, are spaced apart from one another without contact and are coupled to one another.

In such a case, the plurality of spring elements can be coupled to one another in the manner of a lattice or slatted frame and jointly pushed as a preassembled unit in the form of a spring assembly into a receptacle.

In a development of the last-mentioned embodiment, it has proven advantageous if the first receptacle overlaps in the spring direction with a first seat region of the seat surface of the seat unit, on which seat region a first user can be located or is located during operation of the vehicle, and/or if the second receptacle overlaps in the spring direction with a second seat region of the seat surface of the seat unit, on which seat region a second user can be located or is located during operation of the vehicle.

The first user may be, for example, a driver of the vehicle. The second user may be, for example, what is referred to as a pillion rider. In such a case, different seat hardnesses are adjustable by arrangement of at least one spring element or at least one spring assembly in the first receptacle or in the second receptacle.

Finally, it has proven advantageous if the padding unit comprises, on the side facing the seat surface, at least one padding body which is secured to the hard-shelled trough element, and/or if the padding unit comprises at least one cover which externally covers the externally accessible surface of the padding body in sections or as a whole and/or which externally covers the externally accessible surface of the at least one region of the trough element in sections or as a whole.

Further features, details and advantages of the invention emerge from the attached claims, from the graphical illustration and description below of a preferred embodiment of the seat device.

### BRIEF DESCRIPTION OF THE DRAWINGS

FIG. 1 is a sectioned top view of a first exemplary embodiment of the seat device; and

FIG. 2 is a sectioned side view along the line AA according to FIG. 1.

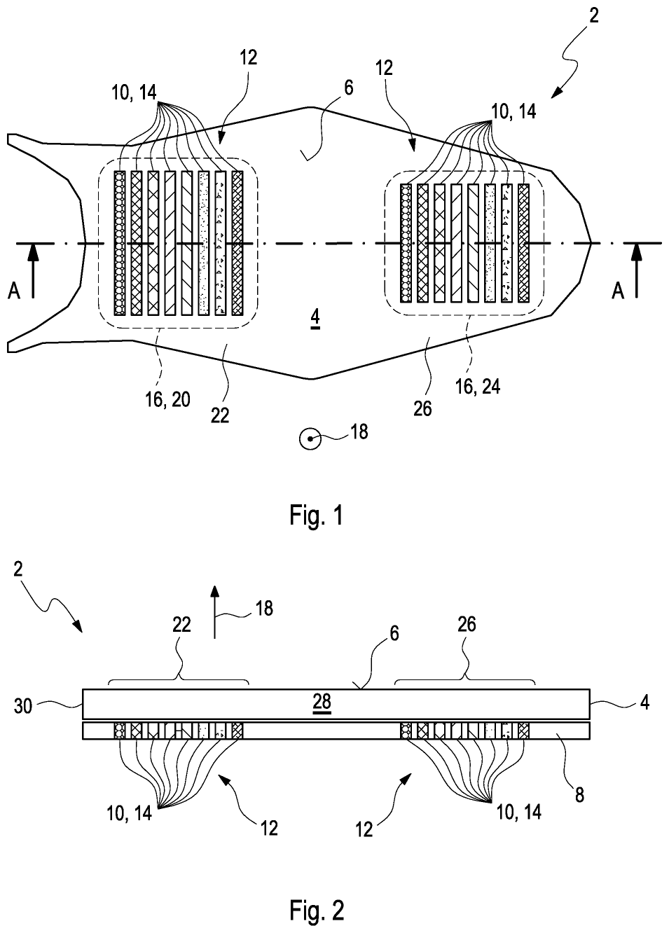

### DETAILED DESCRIPTION OF THE DRAWINGS

The figures show an exemplary embodiment of a seat device, provided overall with the reference sign 2, for a vehicle, in particular tilting vehicle (not explicitly illustrated in the figures). The seat device 2 comprises a planar padding unit 4 which forms, on a surface facing a user of the vehicle, a seat surface 6 for the user of the vehicle.

Furthermore, the seat device 2 comprises a trough element 8 which is hard-shelled at least in sections and to which the padding unit 4 is secured.

Furthermore, the seat device 2 comprises a spring unit 10 which is arranged between the padding unit 4 and trough element 8 and which, in the exemplary embodiment shown in the figures, comprises a plurality of spring elements 14 which form a spring assembly 12, are arranged between the padding unit 4 and trough element 8 and secured in a receptacle 16 which is arranged in the trough element 8. By means of the spring elements 14, a spring force acting between the padding unit 4 and trough element 8 is adjustable, the force vector of which spring force runs parallel or obliquely to a spring direction 18 extending transversely with respect to the seat surface 6.

In the exemplary embodiment shown in the figures, the seat device 2 comprises two receptacles 16, wherein a first receptacle 20 is assigned to a first seat region 22 of the seat surface 6 and a second receptacle 24 is assigned to a second seat region 26 of the seat surface 6.

In the exemplary embodiment shown in the figures, a plurality of spring elements 14 are each coupled to one another to form a spring assembly 12. By this means, a plurality of spring elements 14 can be jointly arranged as a spring assembly 12 in the respective receptacle 16. In the receptacles 16, the individual spring elements 14 are secured against moving in or counter to the spring direction 18 or are limited in respect of their movement against moving in the spring direction 18.

The spring elements 14 are combined as a spring assembly 12 in such a manner that they are coupled to one another in a manner running parallel to one another and spaced apart from one another. In this case, the respective spring element 14, in particular two mutually adjacent spring elements 14, comprise a spring rate in each case differing from one another.

The padding unit 4 of the seat device 2 comprises a padding body 28 which is secured to the hard-shelled trough element 8, and a cover 30 which covers the externally accessible surface of the padding body 28 as a whole and is fixed at least in regions to the hard-shelled trough element 8.

The features of the invention disclosed in the above description, in the claims and in the drawing may be essential both individually and also in any desired combination in the implementation of the invention in its various embodiments.

### LIST OF REFERENCE SIGNS

2 seat device
4 padding unit
6 seat surface
8 trough element
10 spring unit
12 spring assembly
14 spring element(s)
16 receptacle
18 spring direction
20 first receptacle
22 first seat region
24 second receptacle
26 second seat region
28 padding body
30 cover

1.-10. (canceled)

11. A seat device for a vehicle, comprising:
at least one planar padding unit which forms a seat surface for a user of the vehicle on a surface facing the user of the vehicle;
at least one trough element which is hard-shelled at least in sections and to which the padding unit is secured; and
at least one spring unit arranged between the padding unit and the trough element, the spring unit having at least one spring element arranged between the padding unit and trough element, wherein
the at least one spring element is secured releasably in or to the trough element and by which a spring force acting between the padding unit and trough element is adjustable, a force vector of said spring force running parallel or obliquely to a spring direction extending transversely with respect to the seat surface.

12. The seat device according to claim 11, wherein
the trough element has a receptacle comprising a cavity arranged in or on the trough element and into which the at least one spring element is introducible manually or automatically along a joining direction and is secured counter to a movement in the spring direction or a movement in the spring direction is limited.

13. The seat device according to claim 12, wherein at least one of:
(i) the trough element comprises, on a surface extending transversely or obliquely with respect to the seat surface, an opening through which at least one of the at least one spring elements is introducible into the receptacle and the joining direction runs transversely or obliquely with respect to the spring direction,
(ii) the padding unit is transferred relative to the trough element from a secured arrangement into an open arrangement in which the receptacle is accessible from the outside and at least one of the at least one spring elements is introducible into the receptacle, and the joining direction runs in or obliquely with respect to the spring direction, or
(iii) the trough element comprises, on the side facing away from the padding unit, a cutout through which at least one of the at least one spring elements is introducible into the receptacle, and the joining direction runs in or obliquely with respect to the spring direction.

14. The seat device according to claim 12, wherein
the spring unit comprises at least two spring elements which are arranged running obliquely or parallel to one another.

15. The seat device according to claim 14, wherein at least two of the at least two spring elements are formed from a same material or from different materials, and wherein:
at least one of the at least two spring elements comprises a metal or a plastic, and/or
at least two of the at least two spring elements have a same spring rate or at least two of the at least two spring elements each have a spring rate differing from one another.

16. The seat device according to claim 14, further comprising:
at least one adjuster for adjusting the spring force of a system containing the at least two spring elements, which adjuster is movable along an adjustment direction running transversely or obliquely with respect to the spring direction,
wherein movement of the adjuster along the adjustment direction enables a distance between the at least two spring elements with respect to one another to be adjustable.

17. The seat device according to claim 14, wherein
the spring unit comprises at least one spring assembly which is arranged in the at least one receptacle and has at least two spring elements which are arranged running parallel to one another, are movable relative to one another, are spaced apart from one another without contact, and are coupled to one another.

18. The seat device according to claim 11, wherein
the trough element comprises at least two receptacles,
at least one of the at least one spring elements or at least one spring assembly is arranged in a first receptacle, and
at least one of the at least one spring elements or at least one spring assembly is arranged in a second receptacle.

19. The seat device according to claim 18, wherein
the first receptacle overlaps in the spring direction with a first seat region of the seat surface of the seat unit, on which first seat region a first user can be located or is located during operation of the vehicle, and/or
the second receptacle overlaps in the spring direction with a second seat region of the seat surface of the seat unit, on which second seat region a second user can be located or is located during operation of the vehicle.

20. The seat device according to claim 11, wherein
the padding unit comprises, on the side facing the seat surface, at least one padding body which is secured to the hard-shelled trough element, and/or
the padding unit comprises at least one cover which externally covers an externally accessible surface of the padding body in sections or as a whole and/or which externally covers the externally accessible surface of the at least one region of the trough element in sections or as a whole.
